(19) United States
(12) Patent Application Publication
(10) Pub. No.: US 2006/0051722 A1
(43) Pub. Date: Mar. 9, 2006

(54) Dental matrix cover

(76) Inventor: Brian Connell, New Orleans, LA (US)

Correspondence Address: KEATY PROFESSIONAL LAW CORPORATION;THOMAS S. KEATY, 2533 AMERICAN WAY, PORT ALLEN, LA, 70767, US

(21) Appl. No.: 10/935,366

(22) Filed: Sep. 7, 2004

(51) Int. Cl. A61C 5/12

(52) U.S. Cl. 433/138

(57) ABSTRACT

A dental matrix cover for protecting a healthy tooth, while a dental procedure is being performed on an adjacent diseased tooth. The flexible deformable cover body is sized and configured to be placed over the healthy tooth and cover at least the top and a proximal side of the healthy tooth. A flexible band is secured along and near the lower edge of the cover; the band is longer than the length of the lower edge, allowing free ends of the band to extend outside of the cover body and be manually handled for tightly encasing the tooth with the cover. The exterior surface of the cover has a non-stick coating to prevent filling material from the adjacent work site from adhering to a healthy tooth.

### BACKGROUND OF THE INVENTION

The present invention relates to a dental matrix formed from a flexible material and positionable in interproximal space while dental work is performed on one of the teeth.

Dental matrices have been extensively used in the dental art for retaining a packed filling material in the tooth with or without clamping mechanisms. A conventional matrix strip is a rectangular band of about one-half inch wide and about four inches long with a minimal thickness of about one-thousand of an inch. Several such matrices are used for retaining a packed filling material in a tooth; they are usually manually held by the dentist while the filling settles or hardens.

One of the known dental matrices is shown in U.S. Pat. No. 5,975,906 issued on Nov. 2, 1999, which discloses a dental strip made of uniformly thick, soft polymer which allows rapid matrix molding of restorative material applied to the tooth. The matrix in accordance with '906 patent is said to permit the formation of interproximal tooth restoration without wedging. Another known dental matrix is disclosed in U.S. Pat. No. 6,619,956 issued on Sep. 16, 2003. The '956 patent teaches an elongated dental matrix strip with a raised portion situated in such a way that when inserted between the teeth, an interference fit occurs. The strip supports the filling materials in the tooth cavity while it hardens without the need for a separate wedge device.

There are also known devices for spacing teeth during a dental procedure. Once of such devices is disclosed in U.S. Pat. No. 5,505,618 issued on Apr. 9, 1996. In accordance with the '618 patent, the spacer is formed as an elongated body having two opposite side edges extending between gingival and occlusal edges. The middle part of the elongated body is recessed so that it may be inserted between adjacent teeth while minimizing any wedging of the teeth apart.

While the abovementioned devices may work satisfactory in many circumstances, it was noted that many of the known devices have a disadvantage of being too small and too thin, which makes it very difficult to have the matrix properly positioned and then maintained in an upright position while the filling is hardening. Even though the width of the strip is designed to extend over the entire interproximal surface of the tooth, the filling material may still have a chance to ooze from above or below the strip. Additionally, the soft material, being difficult to manually hold in place, may slip and wedge itself between the teeth, without covering the desired area.

Another shortcoming of the known dental strips is the inability to prevent adhering of the filling material to the dental strips. In some cases, when the filling is still wet, the filling material tends to stick to the dental strip and make it difficult to remove once the filling is hardened.

The present invention contemplates elimination of drawbacks associated with the prior art and provision of a dental matrix that substantially covers the entire tooth of the patient, while preventing adhesion of the filling material to the matrix.

### SUMMARY OF THE INVENTION

It is therefore an object of the present invention to provide a dental matrix which is simple to use and inexpensive to manufacture and which is capable of substantially encasing the tooth, while allowing performance of a dental procedure on the adjacent tooth.

It is another object of the present invention to provide a dental matrix, which has a non-stick exterior surface preventing the filling material from adhering to the matrix.

These and other objects of the present invention are achieved through a provision of a flexible body sized and configured to be placed over a tooth located adjacent to a site of a dental procedure. The cover has a top shaped to cover the top of a patient's tooth and at least one side, which is forced into an interproximal cavity between the adjacent teeth. A flexible band is secured along and near the lower edge of the cover. The band has longitudinal dimensions greater than the longitudinal dimension of the cover's lower edge, allowing free ends of the band to extend outside of the cover body.

The body has a geometric cross-section with at least three sides. One side covers the proximal surface and two sides cover opposing front and back surfaces of the tooth. The cover is dimensioned to extend from over the top of the tooth to about the incisal line of the gum. The exterior surface of the cover has a non-stick coating to prevent filling material from the adjacent work site from adhering to a healthy tooth.

### BRIEF DESCRIPTION OF THE DRAWINGS

Reference will now be made to the drawings, wherein like parts are designated by like numerals and wherein

FIG. 1 is a perspective view of the matrix cover of the present invention positioned on the teeth adjacent to the tooth where the dental procedure is being performed.

FIG. 2 is a top view of the matrix cover showing the matrix in place, with the top portion being removed to illustrate substantially peripheral engagement of the teeth by the matrix.

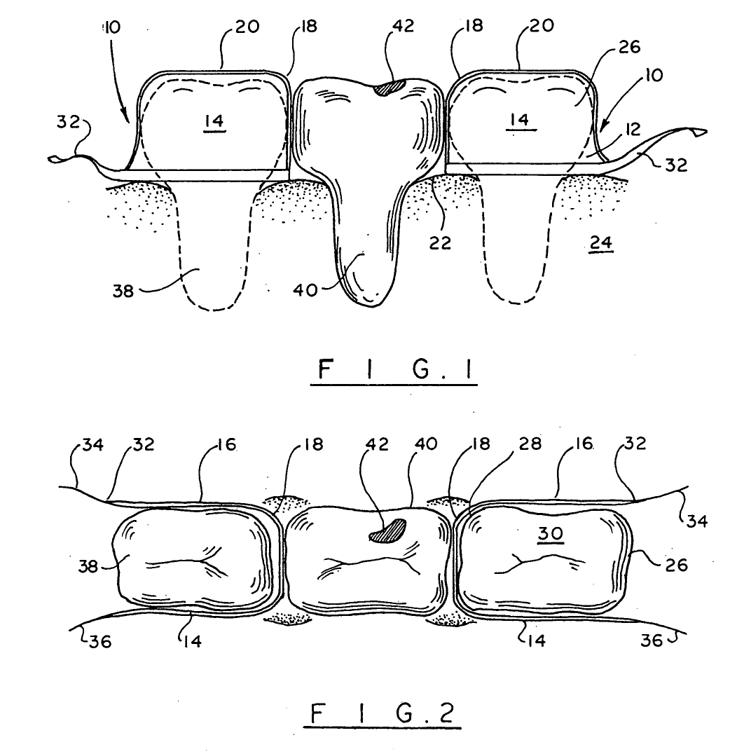

### DETAILED DESCRIPTION OF THE PREFERRED EMBODIEMENT

Reference will now be made to the drawings, wherein numeral 10 designates the matrix body in accordance with the present invention. As can be seen in the drawing, the matrix 10 comprises an irregularly-shaped body 12 having a first side 14, a second side 16, a third side 18 and a top portion 20. The height of the first side 14 and of the second side 16 is sufficient to substantially encase the exposed portion of a human tooth just slightly above an incisal edge 22 of the gum 24. The length of the sides 14 and 16 is substantially equal to or slightly greater than the width of the human tooth 26. The linear dimension of the side 18 is substantially equal to the linear dimension of the proximal surface 28 of the tooth 26. The top portion 20 has a surface approximately equal to or slightly greater than the top surface 30 of the tooth 26.

Extending along the peripheral lower edge of the matrix 10 is an elongated band 32, which has a linear dimension greater than the combined extensions of the sides 14, 16, and 18. The band 32 has opposing free ends 34 and 36, which extend outside of the bottom edge of the sides 14 and 16. The dentist uses the free ends 34 and 36 to pull the encasing matrix 10 over the tooth 26 and to move it tighter about the tooth 26. The band 32 may be made from soft, flexible material similar to the material used for the manufacture of dental tapes.

The matrix 10 has an exterior surface coated with a non-stick material, for instance a thin layer of Teflon® or similar material, which prevents filling material from adhering to the matrix surface. The matrix is formed from soft, deformable, flexible material, which easily conforms to the shape of the human tooth and allows to substantially enclose the tooth 26 about the incisal edge 22 of the gum 24.

A similar matrix 10 may be positioned on the tooth 38 on the opposite side of the tooth 40, on which the dental procedure is performed. In this manner, the tooth 40 is effectively isolated from the adjacent teeth 38 and 26 and the filling material 42 may be safely deposited into the excavated portion of the tooth 40.

In operation, the dentist positions the matrices 10 over the teeth adjacent to the tooth wherein the dental procedure is to be performed. The dentist manually pulls on the ends 34 and 36 of the band to make sure that the sides 18 closely follow the contours of the teeth 26 and 38, without bunching and without creating unnecessary thickness in the tight spaces between the adjacent teeth. The band 32 being made of soft material, can be either held in place by hand or wedged between the proximal teeth on opposite sides of the teeth 26 and 38.

The sides 18 of the matrices are forced to stay in place by the pulling force applied to the bands 32. The matrices 10 substantially encase the teeth adjacent to the tooth 40 and prevent the filling material 42, if crumbled or dropped, from depositing on the adjacent teeth. As a result, the need for polishing the adjacent teeth, should the filling accidentally adhere to the proximal surfaces, is minimized or altogether eliminated.

If desired, the band 32 may be secured to extend along or near the outer surface of the sides 14, 16, and 18. Alternatively, encasing sleeves may be formed along the bottom edge of the sides 14, 16, and 18 and the band 32 can be inserted in the sleeve, with the ends 34 and 36 extending from the sleeve outwardly and allowing manipulation of the matrices 10 to a desired position over the proximal teeth.

Many changes and modifications can be made in the design of the present invention without departing from the spirit thereof. I, therefore, pray that my rights to the present invention be limited only by the scope of the appended claims.

I claim:

1. A dental matrix cover, comprising:
a flexible body adapted for positioning on a first tooth located adjacent to a second tooth having a site of a dental procedure, said body being sized and configured to cover at least a top surface and a proximal surface of the first tooth.

2. The cover of claim 1, further comprising an elongated flexible band secured along and near a lower edge of said cover.

3. The cover of claim 1, wherein said body comprises an exterior surface and wherein a coating of non-stick material is deposited on said exterior surface.

4. The cover of claim 3, wherein said band has a linear dimension at least slightly greater than a linear dimension of the lower edge.

5. The cover of claim 1, wherein said body has a first side sized and shaped to substantially cover a front surface of the first tooth, a second side sized and shaped to substantially cover a back surface of the first tooth, a third side sized and shaped to substantially cover the proximal surface of the first tooth and a top portion sized and shaped to substantially cover the top surface of the first tooth.

6. The cover of claim 5, wherein said proximal side is adapted for wedging between adjacent first and second teeth.

7. The cover of claim 1, wherein said body has a geometric cross-section with at least three sides.

8. The cover of claim 1, wherein said body is formed from a flexible deformable material to facilitate conforming of the body to an exterior surface of the first tooth when positioned on the first tooth.

9. A dental matrix cover for protecting a tooth located adjacent to a diseased tooth having dental procedure performed thereon, said cover comprising:
a flexible body to be placed about said tooth, said body being configured to cover at least a top and a proximal surface of said tooth located adjacent to the diseased tooth.

10. The dental cover of claim 9, wherein said body has a lower edge and wherein said cover further comprises an elongated flexible band secured along and near the lower edge, said band having a length at least slightly greater than the length of the lower edge.

11. The dental cover of claim 9, wherein said body comprises an exterior surface and wherein a coating of non-stick material is deposited on said exterior surface.

12. The cover of claim 9, wherein said body has a geometric cross-section with at least three sides.

13. A method of protecting a tooth located adjacent to a site of a dental procedure, comprising the steps of:
providing a dental matrix cover comprising a flexible body sized and shaped to be placed over the tooth;
providing a flexible band secured along and near a lower edge of said body;
positioning said body over the tooth such that at least one side of said cover is placed in an interproximal cavity between adjacent teeth and a top of said cover extends over a top of the tooth.

14. The method of claim 13, further comprising a step of forming said band with free ends extending outwardly from the lower edge.

15. The method of claim 14, further comprising a step of pulling on said free ends so as to tightly insert the lower edge above an incisal edge of a patient's gum.

16. The method of claim 13, wherein said body has an exterior surface and wherein a coating of non-stick material is deposited on said exterior surface.
